(19) United States
(12) Patent Application Publication
(10) Pub. No.: US 2011/0052765 A1
(43) Pub. Date: Mar. 3, 2011

(54) MARINADE INJECTOR

(76) Inventor: Chris J. Lyden, Auburn, WA (US)

(21) Appl. No.: 12/871,637

(22) Filed: Aug. 30, 2010

Related U.S. Application Data
(60) Provisional application No. 61/238,460, filed on Aug. 31, 2009.
(60) Provisional application No. 61/328,470, filed on Apr. 27, 2010.

(51) Int. Cl. A23L 1/318; A23B 4/28

(52) U.S. Cl. 426/231; 99/533

(57) ABSTRACT

A device, system, and method for injecting an injection substance into one or more food objects is provided. The system further provides for detection of the position of injectors relative to the food objects to selectively provide and remove injection pressure to the injectors and to selectively provide and remove movement to the food objects.

### CLAIM FOR PRIORITY

The present application claims priority to U.S. Provisional Application 61/238,460 filed Aug. 31, 2009, and to U.S. Provisional Application 61/328,470 filed Apr. 27, 2010 the disclosures of which are incorporated herein by reference.

### FIELD

The present disclosure relates to a system and a method for injecting an injection substance into a plurality of food products. More specifically the present disclosure relates to a system and a method for controlling the injection of an injection substance into a plurality of food products on a conveyor with reduced damage to the food products and reduced injection substance loss.

### BACKGROUND ART

A marinade is a solution which food products are generally soaked in prior to cooking Marinades generally consist of a mixture of liquid ingredients, such as water, oil, or wine, and solid ingredients such as spices, herbs, or seasoning. Marinating food products serves multiple functions including increasing flavor, protecting the food product during the cooking process, and tenderizing the food product. Marinades also may serve to hold in moisture in food products, prior to cooking, and serve to reduce moisture loss during the cooking process.

Although the process of marinating food products is generally thought to consist of a process by which food products are soaked in a marinade, achieving the desired results from marinating a food product may be furthered by creating direct contact between the marinade and internal portions of the food product. Thus, the process of marinating a food product may also be accomplished, by injecting a marinade solution directly into a food product. The food processing industry currently employs the process of injecting marinade into many food products such as meat, poultry, and fish.

The process of injecting a marinade into food products, however, presents certain issues for the food industry with regards to efficiency and damage to the food products. Further, because marinades generally consist of both liquid and solid state ingredients, issues associated with the marinade and equipment used in the mass marinade injection process exist. For example, it is not uncommon for the solid ingredients of the marinade to clog the injector devices of a marinade injector machine. Additionally, the liquid and solid ingredients of the marinade, when used under the conditions presented in mass production injector machines, may react in a manner which causes the marinade ingredients to separate, degrade, or form chemical bonds in which the physical state changes to form emulsifications or mixtures.

Issues associated with injection marinating of food products present various problems for the food production industry, including down-time for injector machine equipment, the loss of marinade ingredients, the destruction of food products, creation of puncture holes in the food product, inability to control the amount of marinade injected into the product, and the need for timely and costly repairs to equipment. As a result of these and other potential issues, there exists a need for a system and a method by which food products on a mass production scale can be injected with various forms of marinade in a manner that does not damage the food product, does not cause the marinade ingredients to separate or undergo undesirable physical state changes, and does not cause malfunctioning of the marinade injector machinery. Further, a system and method which allows for limiting the size of puncture holes in the food product and allows for control over the amount of marinade injected is desired.

### SUMMARY

The present disclosure involves a system and a method for injecting an injectable substance, such as a marinade, into an object or a plurality of objects, such as food products.

According to one embodiment, an injector device is provided comprising an injector for injecting a substance into an object; and a controller mechanism capable of detecting the location of an object to be injected, selectively isolating pressure from the substance to be injected based upon the detected location of the object to be injected, and preventing movement of the object to be injected based upon the detected location of the object to be injected.

According to another embodiment of the present disclosure, an injector device is provided comprising an injector for injecting a substance into a foodstuff, the injector including at least one injection conveyance; a first sensor for determining the location of the injection conveyance relative to an object to be injected, wherein the first sensor emits a signal that controls the supply of injection pressure to the injection conveyance and selectively isolates the injection conveyance from the injection pressure based upon the detected location of the injection conveyance; and a second sensor for detecting the location of the injection conveyance, wherein the second sensor emits a signal that controls the movement of the object to be injected and selectively prevents the movement of the object to be injected based upon the detected location of the injection conveyance.

According to another embodiment of the present disclosure, a system for injecting an injection substance into a plurality of food objects is provided. The system comprising: a reservoir capable of holding the injection substance; a plurality of injectors for injecting the injection substance into a plurality of food objects; a pressure source capable of advancing the injection substance from the plurality of injectors into the plurality of food objects; a transport apparatus capable of moving the plurality of food objects from a first location to a second location; and a controller mechanism capable of detecting the location of the plurality of food objects, capable of selectively isolating the injection pressure from the substance to be injected, and capable of selectively preventing the movement of the plurality of objects to be injected.

According to yet another embodiment, a method for injecting a foodstuff with an injectable substance is provided. The method comprising the steps of placing an injectable substance into a reservoir; advancing the injectable substance from the reservoir to a plurality of injectors; positioning the foodstuff on a transportation apparatus capable of moving the foodstuff from a first location to a second location; electronically detecting the location of the foodstuff on the transportation apparatus; selectively preventing the transportation apparatus from moving the plurality of foodstuffs based upon the detected location of the injectors relative to the foodstuff; providing an injection pressure to a plurality of injectors based upon the detected location of the injectors relative to the foodstuff; and selectively isolating the injection pressure from the plurality of injectors based upon the detected location of the injectors relative to the foodstuff.

Additional features of the present disclosure will become apparent to those skilled in the art upon consideration of the following detailed description of the illustrative embodiment.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a plan view of an injector system for injecting marinades into foodstuffs, shown with a portion of an outer housing cut-away; and

FIG. 2 is a perspective view of an injector system for injecting marinades into foodstuffs, shown with a portion of an outer housing and an inner housing cut-away.

Although the drawings represent embodiments of the present disclosure, the drawings are not necessarily to scale and certain features may be exaggerated in order to better illustrate and explain the present disclosure. The exemplifications set out herein illustrate embodiments of the disclosure and such exemplifications are not to be construed as limiting the scope of the invention in any manner.

### DETAILED DESCRIPTION OF THE DRAWINGS

The embodiments of the disclosure described herein are not intended to be exhaustive or to limit the disclosure to precise forms disclosed. Rather, the embodiments selected for description have been chosen to enable one skilled in the art to practice the disclosure.

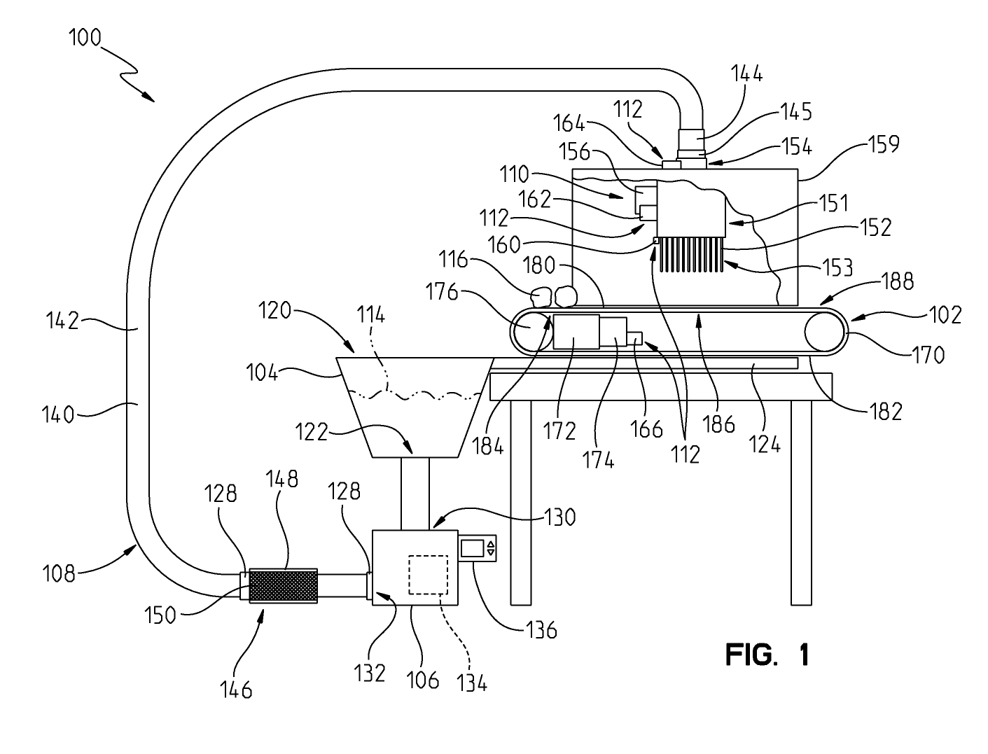

Referring to FIG. 1, marinade injector 100 is illustrated as having reservoir 104, conveyor apparatus 102, pump 106, transfer conduit 108, puncturing apparatus 110, and controller mechanism 112. The embodiment illustrated in FIG. 1 includes an injection substance 114 within the reservoir 104 and a plurality of foodstuffs 116 positioned on the conveyor apparatus 102.

FIG. 1 further illustrates reservoir 104 including receiving area 120, overflow retainment area 124, and output area 122 in communication with pump 106. Communication between reservoir 104 and pump 106 is illustrated as comprising pipe 123.

Pump 106 is illustrated in FIG. 1 including intake area 130, ejection area 132 in physical communication with transfer conduit 108, motor 134, and motor controller unit 136 having pressure sensing mechanism 128 for measuring the pressure of injection substance 114 at one or more of locations in marinade injector 100. The illustrated embodiment of FIG. 1 depicts pressure sensing mechanism 128 configured to sense the pressure of injection substance 114 at ejection area 132 of pump 106 and in channel 142 of transfer conduit 108 past filter 146. However, alternate configurations of pressure sensing mechanism 128 are envisioned, for example embodiments of marinade injector 100 are envisioned in which pressure sensing mechanism 128 is configured to sense the pressure of injection substance 114 at valve 144. Further, although the present embodiment depicted in FIG. 1 illustrates motor controller unit 136 as attached to, or part of pump 106, alternate embodiments are envisioned in which motor controller unit 136, while electrically coupled to pump 106, is separate from pump 106.

FIG. 1 further illustrates transfer conduit 108 as including outer enclosure 140, valve 144, and filter 146. Outer enclosure 140 comprises one or more of a tube, hose, pipe, or canister, defining channel 142 by which injection substance 114 passes from pump 106 to puncturing apparatus 110. As illustrated in the present embodiment, transfer conduit 108 includes valve 144, capable of interrupting flow in channel 142 to fluidly isolate pump 106 from puncturing apparatus 110. Valve 144 is shown as a normally closed air valve that, when activated, allows pressurized marinade to be provided to puncturing apparatus 110.

Continuing with FIG. 1, filter 146 is illustratively positioned in channel 142 of transfer conduit 108 between pump 106 and valve 144. In the present embodiment filter 146 comprises outer casing 148 and internal mesh surface 150. Internal mesh surface 150 is positioned within channel 142 of transfer conduit 108 through which injection substance 114 passes. Although the illustrated embodiment depicts filter 146 as being positioned in channel 142 of transfer conduit 108 between pump 106 and valve 144, alternate embodiments are envisioned. For example, it is envisioned that filter 146 may be positioned in the communication passage between reservoir 104 and pump 106 or filter 146 may be positioned as part of ejection area 132 of pump 106, or alternatively filter 146 may be positioned in channel 142 of transfer conduit 108 between valve 144 and puncturing apparatus 110. It is further envisioned that embodiments of marinade injector 100 may comprise more than one filter 146 in multiple positions.

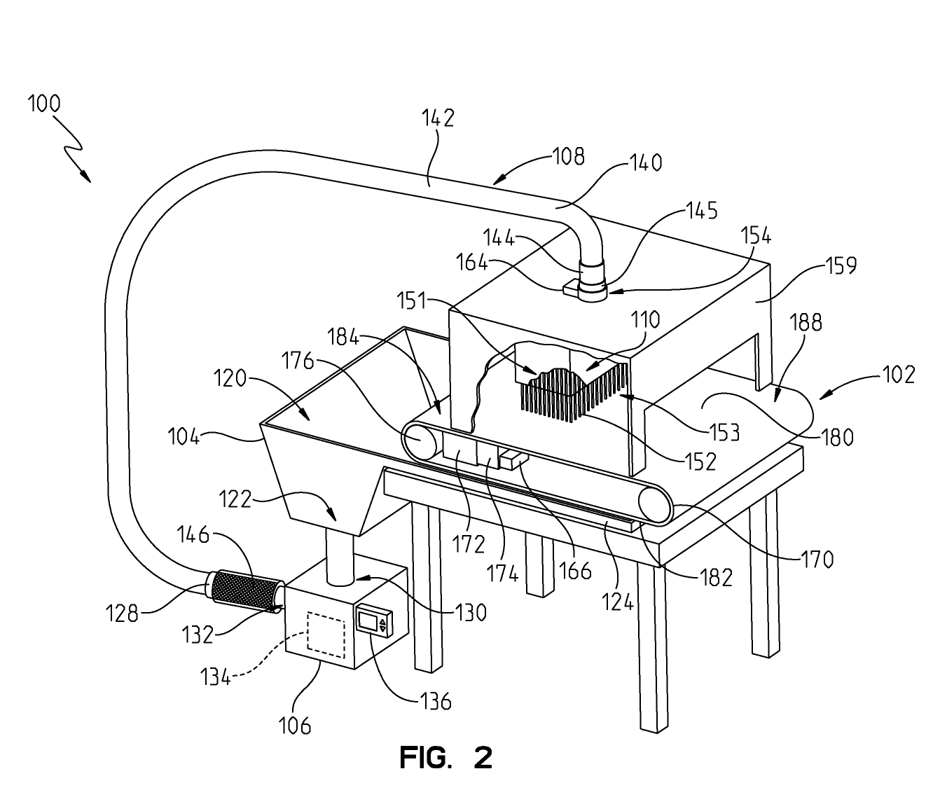

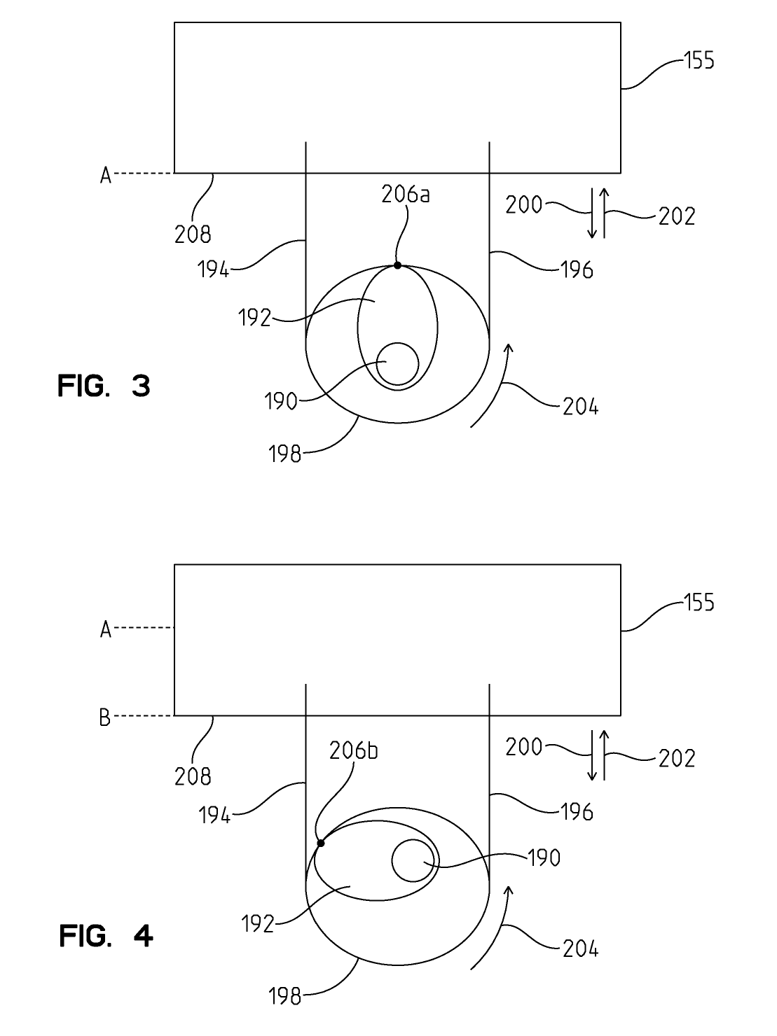

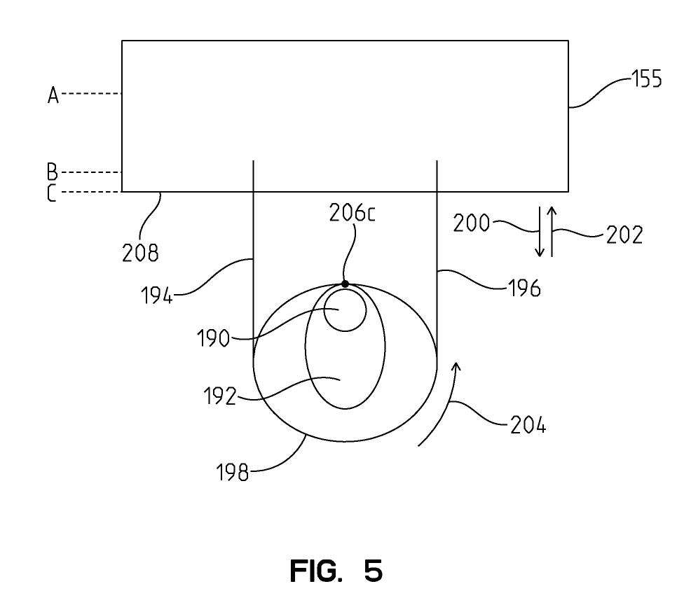

Puncturing apparatus 110 is illustrated as having a plurality of injection conveyances 152, injection substance receiving port 154, and conveyance drive motor 156. Although FIG. 1 illustrates puncturing apparatus 110 as comprising a single row of injection conveyances 152, it should be appreciated that puncturing apparatus 110 comprises a plurality of rows of injection conveyances 152 with each row containing a plurality of injection conveyances 152 (see FIG. 2). Further, it is envisioned that the number of injection conveyances 152 may be adjustable based on foodstuffs 116 to be injected, the amount of injection substance 114 to be delivered, and to otherwise customize the delivery of injection substance 114.

Referring to FIG. 2, individual injection conveyances 152 are illustrated as having a loading region 151 and a puncturing region 153. Although puncturing region 153 of injection conveyances 152 are illustrated in the form of a needle, it is envisioned that puncturing region 153 may take other forms capable of introducing injection substance 114 into foodstuffs 116. Further, although FIG. 2 depicts loading region 151 as being disposed within housing 157 internal to housing 159, it is envisioned that loading region 151 may alternatively be either partially disposed or may not be disposed within housing 157 internal to housing 159. Movement of plurality of injection conveyances 152 is effected by conveyance drive motor 156. Conveyance drive motor 156 selectively raises and lowers the plurality of injection conveyances 152 as instructed by controller mechanism 112. Operation of drive motor 156 is further described below with reference to FIGS. 3-5.

Conveyor apparatus 102 is illustrated in FIG. 2 as having feed belt 170, motor 172, and brake 174. Although the illustrated embodiment depicts conveyor apparatus 102 as completely disposed outside of housing 159, it should be appreciated that conveyor apparatus 102 may be may be either partially or fully disposed within housing 159.

Returning briefly to FIG. 1, feed belt 170 illustratively includes top surface 180, bottom surface 182, initiation location 184, injection location 186, and completion location 188. Feed belt 170 is a hinging metal belt that provides many apertures (not shown) therein. The apertures allow any injection substance 114 not retained with foodstuffs 116 to travel through feed belt 170 and to be captured by overflow retainment area 124. Retainment area 124 is illustratively a pan having an bottom surface that is inclined such that injection substance 114 retained thereby travels down the incline and returns to reservoir 104.

Referring to FIG. 2, motor 172 of conveyor apparatus 102 is illustrated as including gear box 176. In the illustrated embodiment motor 172 is positioned between top surface 180 and bottom surface 182 of feed belt 170. Brake 174 is illustrated as integral with motor 172, however alternate positioning of brake 174 is envisioned in any position that permits brake 174 to affect movement of feed belt 170.

Referring to FIG. 1, controller mechanism 112 is illustrated including sensor 160, controller coordination unit 162, first proximity switch 164, and second proximity switch 166.

Sensor 160 is illustrated in FIG. 1 as a light barrier, positioned near the junction of loading region 151 and puncturing region 153 of at least one of the plurality of injection conveyances 152. In the illustrated embodiment, sensor 160 is positioned in such as a manner as to detect when foodstuffs 116 pass under the plurality of injection conveyances 152 and enter injection location 186. Detection of foodstuffs 116 is communicated to controller coordination unit 162. Although the embodiment of FIG. 2 depicts sensor 160 as a light barrier, alternate embodiments of sensor 160 are envisioned.

FIG. 1 illustrates controller coordination unit 162 as adjacent to conveyance drive motor 156, however it should be appreciated that controller coordination unit 162 can be positioned in any manner as long as controller coordination unit 162 is able to electrically couple to sensor 160, first proximity switch 164, and second proximity switch 166. Controller coordination unit 162 is electrically coupled to first proximity switch 164, second proximity switch 166, valve 144, motor 172, and brake 174.

First proximity switch 164 and second proximity switch 166 are positioned to be activated when the plurality of injection conveyances 152 descend towards injection location 186. Activation of first proximity switch 164 and second proximity switch 166 send signals to controller coordination unit 162. The location and settings of first proximity switch 164 and second proximity switch 166 can be adjusted to allow different amounts of travel by the plurality of injection conveyances 152 prior to sending an electrical indication to controller coordination unit 162.

Having described the various portions of marinade injector 100, the operation thereof will now be discussed.

As illustrated in FIG. 1, injection substance 114 is introduced into reservoir 104 through receiving area 120. The process of introducing injection substance 114 into reservoir 104 may be accomplished manually by a user or through an automated process.

According to one embodiment, once inside reservoir 104, gravity feeds injection substance 114 through output area 122 of reservoir 104. Other embodiments are envisioned where suction, rather than gravity, is used to drive injection substance 114 into pump 106. Gravity feed is used for injection substances 114 containing high protein content, hydrophobic content, or components likely to separate from liquid components of injection substance 114, in that gravity feeding provides a reduced likelihood of phase separation of the components of injection substance 114 relative to when suction is used. For injection substances 114 which have little to no risk of undergoing phase separation, suction feeding and gravity feeding are more readily interchangeable for aiding in the transfer of injection substance 114 from reservoir 104 to pump 106. Furthermore, while circumstances have been described indicating when to use different feed mechanisms, all mechanisms are envisioned to be used with all injection substances 114 regardless of their likelihood of phase separation.

Injection substance 114 enters pump 106 at intake area 130. After entering pump 106, motor 134 facilitates the displacement of injection substance 114 through ejection area 132 and into channel 142 of transfer conduit 108.

As injection substance 114 passes into channel 142 of transfer conduit 108, it passes through internal mesh surface 150 of filter 146. In the present embodiment, internal mesh surface 150 is comprised of stainless steel with apertures of specified sizes, for example 0.05 mm, in order to prevent material larger than the specified aperture size from passing through transfer conduit 108 and entering the plurality of injection conveyances 152.

Motor controller unit 136 is used in maintaining the speed of motor 134 as it displaces injection substance 114 into channel 142 of transfer conduit 108. In the illustrated embodiment, motor controller unit 136 is electrically coupled to pressure sensing mechanisms 128 positioned for sensing the pressure of injection substance 114 being displaced through ejection area 132 of pump 106 and for sensing the pressure of injection substance 114 displaced through filter 146. A desired pressure can be entered into a control interface for motor controller unit 136. Pressure sensing mechanisms 128 provide feedback to the control interface to allow motor controller unit 136 to be sped up or slowed down to enable motor controller unit 136 to facilitate and provide a substantially uniform pressure (the pressure chosen via the control interface) of injection substance 114 to the plurality of injection conveyances 152.

Injection substance 114 having a high content of larger matter that is unable to pass through aperture sizes, defined by internal mesh surface 150 of filter 146, may cause filter 146 to become clogged and slow the passage of injection substance 114 through filter 146. Such clogging reduces the pressure of injection substance 114 displaced into channel 142 after passing through filter 146. Pressure sensing mechanisms 128 detect this reduction in injection substance 114 pressure in channel 142 after filter 146 and, based on the pressure sensing mechanism 128 recognition, motor controller unit 136 may either automatically adjust motor 134 speed in order to increase the amount of injection substance 114 being displaced through ejection area 132 of pump 106. Additionally, detection of a large pressure drop across filter 146 alerts an operator who can take manual corrective action such as replacing filter 146 or otherwise.

The embodiment in FIG. 1 illustrates filter 146 as positioned within channel 142 of transfer conduit 108, and thus pressure sensing mechanisms 128 are positioned between ejection area 132 of pump 106 and in channel 142 downstream of filter 146. However, alternate embodiments are envisioned in which filter 146 and pressure sensing mechanisms 128 are positioned elsewhere. For example, an embodiment (not shown) utilizing suction to facilitate the feeding of injection substance 114 from reservoir 104 to pump 106 includes filter 146 positioned in the communication passage feeding injection substance 114 from reservoir 104 to pump 106. When filter 146 is positioned in communication passage between reservoir 104 and pump 106, pressure sensing mechanisms 128 are similarly moved.

As injection substance 114 is driven through channel 142 of transfer conduit 108 towards puncturing apparatus 110, by pressure generated by pump 106, injection substance 114 encounters valve 144. Referring to FIG. 2, valve 144 is illustrated as integral with transfer conduit 108. Valve 144 is further illustrated as a normally closed air operated valve 145 capable of closing off channel 142 of transfer conduit 108 and thus preventing injection substance 114 from entering the puncturing apparatus 110. Although FIG. 2 illustrates valve 144 as air operated valve 145, it is envisioned that alternate forms of valve 144 known in the art would suffice to bar and/or restrict flow of injection substance 114. Further, alternate embodiments are envisioned in which valve 144 is integral with puncturing apparatus 110 or is a separate entity in communication with both transfer conduit 108 and puncturing apparatus 110.

Additionally, valve 144 is electrically coupled to controller mechanism 112. Referring to FIG. 1, the illustrated embodiment depicts first proximity switch 164 of controller mechanism 112 as electrically coupled to valve 144 and as integral with valve 144. However, embodiments in which first proximity switch 164 is not integral with valve 144 are envisioned.

Foodstuffs 116 are positioned on top surface 180 of feed belt 170 at initiation position 184. Foodstuffs 116 may be positioned on feed belt 170 either manually, as illustrated by FIG. 1, or through an automated loading process (not illustrated). Motor 172 drives feed belt 170, transferring foodstuffs 116 from initiation location 184 to injection location 186 to completion location 188.

As illustrated in FIG. 1, as foodstuffs 116 pass from initiation location 184 to injection location 186, foodstuffs 116 pass through light barrier of sensor 160 facilitating the detection of the presence of foodstuffs 116 near injection location 186 by sensor 160. Upon detection of foodstuffs 116 at injection location 186, sensor 160 generates and communicates an electronic signal to controller coordination unit 162. Controller coordination unit 162 controls conveyance drive motor 156. By controlling conveyance drive motor 156, controller coordination unit 162 is able to determine the time between when foodstuff 116 is detected by sensor 160 and when foodstuff 116 will be located in injection location 186. Controller coordination unit 162 further determines when conveyance drive motor 156 is initialized such that conveyances 152 properly engage plurality of foodstuffs 116 at injection location 186. As conveyance drive motor 156 urges plurality of injection conveyances 152 downward, first proximity switch 164 and second proximity switch 166 detect when plurality of injection conveyances 152 has traveled the proper distance such that plurality of injection conveyances 152 engage plurality of foodstuffs 116. First proximity switch 164 is activated before second proximity switch 166 is activated as conveyance drive motor 156 moves plurality of injection conveyances 152 downward. Activation of first proximity switch 164 and second proximity switch 166 send signals to controller coordination unit 162 of controller mechanism 112.

Controller coordination unit 162 is in electronic communication with motor 172 and brake 174. Upon electronic communication from first proximity switch 164, controller coordination unit 162 generates and communicates an electronic signal to motor 172 and brake 174 to effect an operational change thereof. Motor 172 is stopped for the duration of receiving the signal from controller coordination unit 162. Stoppage of motor 172 prevents movement of feed belt 170. As previously noted, first proximity switch 164 is positioned to be engaged when plurality of injection conveyances 152 are engaging plurality of foodstuffs 116. Thus, while the plurality of injection conveyances 152 are in foodstuffs 116, motor 172, feed belt 170, and plurality of foodstuffs 116 are stationary.

Similarly, and shortly after activation of first proximity switch 164 and stoppage of motor 172, feed belt 170, and plurality of foodstuffs 116, second proximity switch 166 is encountered and engaged by descending plurality of injection conveyances 152. Upon receiving a signal from second proximity switch 166, controller coordination unit 162 sends a signal to effect a state change in valve 144. This state change takes valve 144 from its normally closed position to a position urging passage of injection substance 114 from channel 142 to puncturing apparatus 110. Accordingly, once the plurality of injection conveyances 152 are within stationary foodstuffs 116, injection substance 114 is injected therein.

After a pre-set time, or via other indication that an appropriate amount of injection substance 114 has been injected, controller coordination unit 162 emits a control signal to conveyance drive motor 156 instructing it to withdraw the plurality of injection conveyances 152. Alternatively, drive motor 156 includes a constantly rotating take-off or camshaft where the speed of rotation of the motor is set to provide the appropriate amount of injection substance. Retraction of the plurality of injection conveyances 152 first results in deactivation of second proximity switch 166. Deactivation of second proximity switch 166 is communicated to controller coordination unit 162 which causes a second state change in valve 144, fluidly isolating injection substance 114 from puncturing apparatus 110. Additionally, subsequent deactivation of first proximity switch 164 is communicated to controller coordination unit 162 which electronically communicates with motor 172 causing it to re-start movement of feed belt 170 and foodstuffs 116 thereon. It should be appreciated that these stoppages of movement and injection times are very short times, but can be adjusted to any desired lengths of time. Furthermore, it should be appreciated that the deactivation of second proximity switch 166 provides that injection substance 114 ceases to be provided to plurality of injection conveyances 152 prior to plurality of injection conveyances 152 being fully removed from injection substance 114.

The discontinuation of providing injection substance 114 to puncturing apparatus 110 prior to withdrawal of the plurality of injection conveyances 152 from foodstuffs 116 provides reduced loss of injection substance 114 due to that injection substance 114 is not being forcibly ejected from plurality of injection conveyances 152 while the plurality of injection conveyances 152 are outside of plurality of foodstuffs 116. Accordingly, the embodiments described herein act to reduce loss of injection substance 114.

Additionally, overflow retainment area 124 beneath conveyor apparatus 102 allows for recapture of injection substance 114 which may have not been injected into the foodstuffs 116, have leaked from the plurality of injection conveyances 152, or have leaked from the foodstuffs 116 and returns that injection substance 114 to reservoir 104. Although not illustrated in FIG. 1, embodiments are envisioned where a filter mechanism is used in which any captured overflow injection substance 114 passes therethrough before reintroduction to reservoir 104. Such a filtering mechanism reduces potential particles of foodstuffs 116 or other impurities from entering the reservoir 104.

The present system is envisioned to perform the above identified method in a repeated fashion for a plurality of foodstuffs 116 positioned onto feed belt 170. Upon foodstuffs 116 reaching completion location 188, foodstuffs 116 are transferred from conveyor apparatus 102.

As shown in FIGS. 3-5, driveshaft 190 of motor 156 is coupled to cam 192 to translate vertical motion 200, 202 to conveyance block 155 to which injection conveyances 152 are attached. Conveyance block 155 is coupled to linkages 194, 196, 198 such that conveyance block 155 and linkages 194, 196, 198 move as a single unit. FIG. 3 shows the camshaft (driveshaft 190 and cam 192) in a top position. The top position provides a point of maximum elevation for conveyance block 155 that results in injection conveyances 152 being outside of any foodstuff 116. The position of conveyance block 155 is dictated by the point of contact 206a-c between cam 192 and linkage 198. Contact point 206a provides for placement of conveyance block 155 at the top position. When conveyance block 155 is in the top position, the lower edge 208 of conveyance block 155 is at height “A.”

Camshaft 190 & 192 rotates counter-clockwise 204, although moving clockwise would work just as well. FIG. 4 shows camshaft 190 & 192 after it has moved a quarter turn counter-clockwise 204 from the position shown in FIG. 3. The quarter turn results in downward movement 200 of the conveyance block 155 such that lower edge 208 is at height “B.” Height B is below the height at which injection conveyances 152 engage foodstuffs 116. Indeed, injection conveyances 152 engage foodstuffs 116 before reaching the point shown in FIG. 4.

FIG. 5 shows camshaft 190 & 192 after it has moved a quarter turn counter-clockwise 204 from the position shown in FIG. 4, or a half turn from the position of FIG. 3. The position of FIG. 5 shows the low point of travel for conveyance block 155. Lower edge 208 is at height “C” at the low point shown in FIG. 5. It should be appreciated that height C is lower than height B and thus, injection conveyances 152 engage foodstuffs 116 at the low point and at all points between those shown in FIG. 4 and FIG. 5. It should also be appreciated that the difference between height A and height B is significantly greater than the difference in height between height A and height B. Accordingly, the majority of vertical travel occurs when the point of contact 206 and the longer end of cam 192 is in the upper half of its circular travel. Furthermore, it should be appreciated that this setup provides for a greater dwell time, the time that injection conveyances 152 remain in foodstuff 116, during a complete revolution of driveshaft 190. Additionally, the setup provides for slower travel of injection conveyances 152 while in foodstuffs 116 and increased movement speed of injection conveyances 152 when injection conveyances 152 are outside of foodstuffs 116.

A further counter-clockwise quarter turn (not shown) of camshaft 190 & 192 from the position shown in FIG. 5 results in conveyance block 155 moving upwards 200 to place lower edge 208 at height B. Yet another counter-clockwise quarter turn (not shown) of camshaft 190 & 192 returns camshaft 190 & 192 to the position shown in FIG. 3.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. An injector device, comprising:
an injector for injecting a substance into an object; and
a controller mechanism capable of detecting the location of an object to be injected, selectively isolating pressure from the substance to be injected based upon the detected location of the object to be injected, and preventing movement of the object to be injected based upon the detected location of the object to be injected.

2. The injector device of claim 1, wherein the object to be injected comprises a foodstuff.

3. The injector device of claim 1, wherein the substance to be injected into the object comprises a liquid.

4. The injector device of claim 1 further comprising a plurality of injectors.

5. The injector device of claim 1 further comprising a conveyor for moving the object to be injected.

6. The injector device of claim 5, wherein the conveyor further comprises a brake electrically coupled to the controller mechanism.

7. An injector device, comprising:
an injector for injecting a substance into a foodstuff, the injector including at least one injection conveyance;
a first sensor for determining the location of the injection conveyance relative to an object to be injected, wherein the first sensor emits a signal that controls the supply of injection pressure to the injection conveyance and selectively isolates the injection conveyance from the injection pressure based upon the detected location of the injection conveyance; and
a second sensor for detecting the location of the injection conveyance, wherein the second sensor emits a signal that controls the movement of the object to be injected and selectively prevents the movement of the object to be injected based upon the detected location of the injection conveyance.

8. The injector device of claim 7, further including a first sensor controller and a second sensor controller that receive signals from the first and second sensors, respectively.

9. The injector device of claim 8, wherein the first sensor controller and the second sensor controller are embodied in a single controller device.

10. The injector device of claim 7, wherein the selective prevention of movement of the object to be injected involves activation of brake.

11. A system for injecting an injection substance into a plurality of food objects, comprising:
a reservoir capable of holding the injection substance;
a plurality of injectors for injecting the injection substance into a plurality of food objects;
a pressure source capable of advancing the injection substance from the plurality of injectors into the plurality of food objects;
a transport apparatus capable of moving the plurality of food objects from a first location to a second location; and
a controller mechanism capable of detecting the location of the plurality of food objects, capable of selectively isolating the injection pressure from the substance to be injected, and capable of selectively preventing the movement of the plurality of objects to be injected.

12. The system of claim 11, wherein the injection substance advances from the reservoir to the pressure source by means of gravity.

13. The system of claim 11, further comprising a filter system capable of removing particles from the injection substance that large enough to clog at least one of the plurality of injectors.

14. The system of claim 13, wherein the filter system is positioned at a point between the pressure source and the plurality of injectors.

15. The system of claim 11, wherein the plurality of injectors are adjustable in number and splay.

16. A method for injecting a foodstuff with an injectable substance, the method comprising the steps of:
placing an injectable substance into a reservoir;
advancing the injectable substance from the reservoir to a plurality of injectors;
positioning the foodstuff on a transportation apparatus capable of moving the foodstuff from a first location to a second location;
electronically detecting the location of the foodstuff on the transportation apparatus;
selectively preventing the transportation apparatus from moving the plurality of foodstuffs based upon the detected location of the injectors relative to the foodstuff;
providing an injection pressure to a plurality of injectors based upon the detected location of the injectors relative to the foodstuff; and
selectively isolating the injection pressure from the plurality of injectors based upon the detected location of the injectors relative to the foodstuff.

17. The method of claim 16, further including the step of filtering the injectable substance during the advancing of the injectable substance from the reservoir to the injectors.

18. The method of claim 16, further including the step of monitoring the injection pressure at a plurality of locations between the reservoir and the injectors.

19. The method of claim 18, further including the step of adjusting the injection pressure based upon the information obtained from the monitoring of the injection pressure at a plurality of locations between the reservoir and the injectors.

20. The method of claim 19, wherein the step of adjusting the injection pressure based upon the information obtained from the monitoring of the injection pressure at a plurality of locations between the reservoir and the injectors is accomplished manually.
